(19) United States
(12) Patent Application Publication
(10) Pub. No.: US 2023/0135528 A1
(43) Pub. Date: May 4, 2023

(54) COMPUTING DEVICE AND DATA BACKUP METHOD

(71) Applicant: INSTITUTE FOR INFORMATION INDUSTRY, TAIPEI (TW)

(72) Inventors: Jiann Wen WANG, TAIPEI (TW); Zheng Xiu WU, TAIPEI (TW); Wen To HUANG, TAIPEI (TW); Li Hao CHIANG, TAIPEI (TW)

(21) Appl. No.: 17/456,580

(22) Filed: Nov. 25, 2021

(30) Foreign Application Priority Data
Nov. 3, 2021 (TW) 110140978

(51) Int. Cl. G06F 3/06; G06F 9/455

(52) U.S. Cl. CPC G06F 3/0664; G06F 9/45558; G06F 3/0604; G06F 3/0679; G06F 2009/45583

(57) ABSTRACT

A computing device is provided, which includes a volatile memory, a non-volatile memory, and a processor. A processor is configured to execute a main virtual machine for: during a detection period, detecting a cold area used by the main virtual machine from the volatile memory and the non-volatile memory; transmitting first data belonging to the cold area in the volatile memory and the non-volatile memory to a backup device; when determining that a first transmission condition is satisfied, transmitting a second data used by the main virtual machine in the volatile memory and the non-volatile memory to the backup device; and when determining that an abnormal event has occurred, notifying the abnormal event to the backup device, so as to execute a backup virtual machine in the backup device according to the first data and the second data.

### CROSS-REFERENCE TO RELATED APPLICATION

This application claims priority to Taiwan Application Serial Number 110140978, filed Nov. 3, 2021, which is herein incorporated by reference in its entirety.

### BACKGROUND

### Field of Disclosure

The present disclosure relates to a data processing technology. More particularly, the present disclosure relates to a computing device and data backup method.

### Description of Related Art

As network services become a necessity for life operations, there is an increasing demand for service reliability and uninterrupted services. Based on this, backup mechanisms such as backup and disaster recovery (DR) continue to develop to reduce the loss in an event of an accident and the cost of restoring a normal operation of the service. However, in an environment where a bandwidth of network transmission is limited or the bandwidth is changed, a traditional backup mechanism will not be able to efficiently perform backup. Accordingly, how to efficiently perform backup in the environment where the bandwidth of network transmission is limited or the bandwidth is changed is a problem that those skilled in the art are eager to solve.

### SUMMARY

The disclosure provides a computing device, which includes a volatile memory, a non-volatile memory, and a processor. A processor connected to the volatile memory and the non-volatile memory, wherein the processor is configured to execute a main virtual machine for: during a detection period, detecting a cold area used by the main virtual machine from the volatile memory and the non-volatile memory; transmitting first data belonging to the cold area in the volatile memory and the non-volatile memory to a backup device; when determining that a first transmission condition is satisfied, transmitting a second data used by the main virtual machine in the volatile memory and the non-volatile memory to the backup device; and when determining that an abnormal event has occurred, notifying the abnormal event to the backup device, so as to execute a backup virtual machine in the backup device according to the first data and the second data.

The disclosure provides a data backup method, which includes following steps: during a detection period, by a computing device, detecting a cold area used by a main virtual machine from a volatile memory and a non-volatile memory; by the computing device, transmitting first data belonging to the cold area in the volatile memory and the non-volatile memory to a backup device; when determining that a first transmission condition is satisfied, by the computing device, transmitting a second data used by the main virtual machine in the volatile memory and the non-volatile memory to the backup device; and when determining that an abnormal event has occurred, by the computing device, notifying the abnormal event to the backup device, so as to execute a backup virtual machine in the backup device according to the first data and the second data.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of a computing device of the disclosure.

FIG. 2 is a flowchart of a data backup method of the disclosure.

FIGS. 3 to 6 are flowcharts of detailed steps of the data backup method in some embodiments according to the disclosure.

FIG. 7 is a flowchart of controlling data transmission in the data backup method in some embodiments according to the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

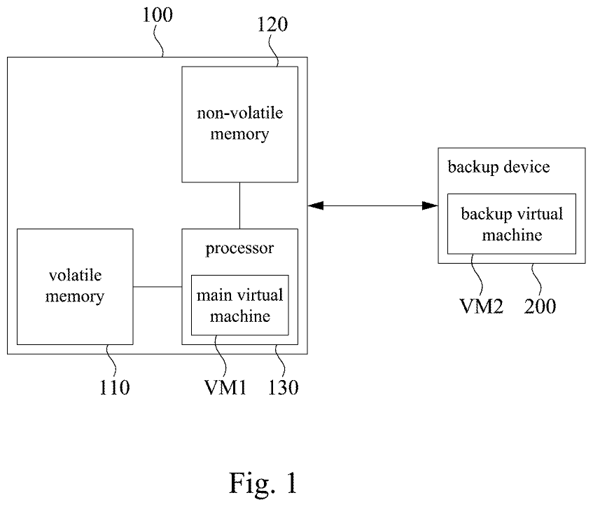

Reference is made to FIG. 1, which is a block diagram of a computing device 100 of the disclosure. In an embodiment, the computing device 100 includes a volatile memory 110, a non-volatile memory 120 and a processor 130. The processor 130 is connected to the volatile memory 110 and the non-volatile memory 120.

In some embodiments, the computing device 100 can be implemented by a computer, a server, or a processing center. In some embodiments, the volatile memory 110 can be implemented using random access memory, dynamic random access memory, static random access memory, or any equivalent storage components. In some embodiments, the non-volatile memory 120 can be realized by a read-only memory, a flash memory, a non-volatile random access memory, a hard disk, a magnetic disk, or any equivalent storage components. In some embodiments, the processor 130 can be implemented by a processing unit, a central processing unit, or a computing unit.

In some embodiments, the computing device 100 is not limited to including the volatile memory 110, the non-volatile memory 120 and the processor 130, and the computing device 100 can further include other components required for operation and applications. For example, the computing device 100 can further include an output interface (e.g., a display panel for displaying information) and an input interface (e.g., a touch panel, a keyboard, a microphone, a scanner, or a flash memory reader).

As shown in FIG. 1, the processor 130 is used to execute a main virtual machine VM1 based on the corresponding software/firmware instruction program.

In some embodiments, the processor 130 can generate and execute the main virtual machine VM1 according to virtual machine specifications and disc image file related information pre-stored in the non-volatile memory 120, where the main virtual machine VM1 can read/write data in the volatile memory 110 and the non-volatile memory 120, and can use virtual hardware or software to execute a corresponding virtual operating system and virtual applications, where the verb of read/write means that is reading, writing or a combination of both.

In some embodiments, the processor 130 can establish a connection with a backup device 200 via a communication circuit (i.e., establish a transmission channel for backup data), and the backup device 200 can generate and execute a backup virtual machine VM2 same as the main virtual machine VM1.

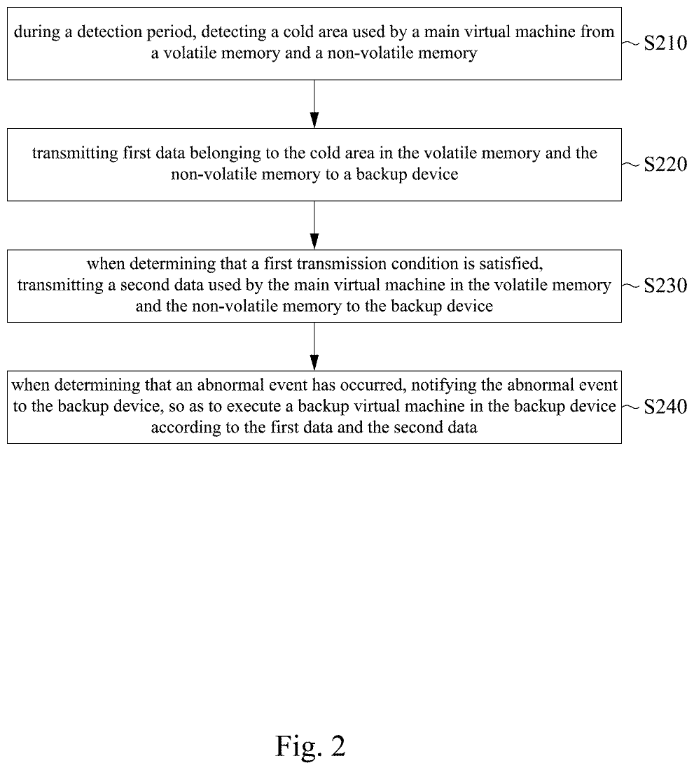

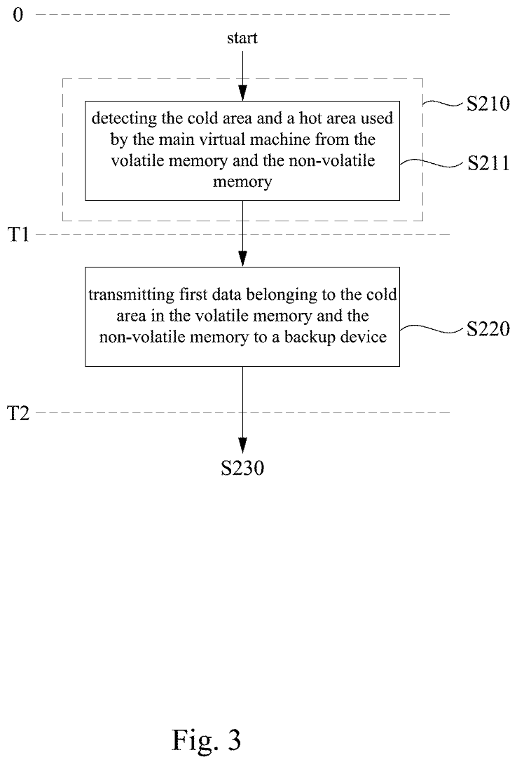

Reference is made to FIG. 2, which is a flowchart of a data backup method of the disclosure. The computing device 100 shown in FIG. 1 can be used to execute the data backup method in FIG. 2, where the data backup method includes steps S210 to S240.

As shown in FIG. 2, in step S210, during a detection period, detecting a cold area used by the main virtual machine VM1 from the volatile memory 110 and the non-volatile memory 120. In some embodiments, the cold area can be a data storage area in the volatile memory 110 and the non-volatile memory 120, and a read-write rate of the main virtual machine VM1 to data in the cold area can be less than a preset read-write rate threshold. In some embodiments, the detection time period can be decided by the recovery point objective (RPO) time. It should be noted that the recovery point objective time is a maximum acceptable length of time for data recovery, which will decide an acceptable data loss between a time point of data recovery and a time point of service interruption.

Furthermore, in step S220, transmitting first data belonging to the cold area in the volatile memory 110 and the non-volatile memory 120 to the backup device 200. Furthermore, in step S230, when determining that a first transmission condition is satisfied, transmitting a second data used by the main virtual machine VM1 in the volatile memory 110 and the non-volatile memory 120 to the backup device 200. In some embodiments, the first transmission condition can be that a data amount of the first data is equal to a first transmission threshold or time taken to transmit the first data is equal to a preset time threshold.

Furthermore, in step S240, when determining that an abnormal event has occurred, notifying the abnormal event to the backup device 200, so as to execute the backup virtual machine VM2 in the backup device 200 according to the first data and the second data. In some embodiments, the abnormal event can be a network failure between the computing device 100 and the backup device 200 detected by a network detection circuit (not shown) in the computing device 100, a network failure between the computing device 100 and the backup device 200 detected by the network detection circuit by a method of heartbeat detection, a network failure between the computing device 100 and the backup device 200 detected by an external detection device, or transfer of a virtual machine triggered by a user. Specific examples will be followed to further explain the detailed steps of steps S210 to S240 in some embodiments.

It should be noted that the above-mentioned steps S210 to S230 can be periodically performed at multiple backup time points. In addition, the above-mentioned steps S210 to S230 can also be executed immediately when the above-mentioned abnormal event occurs. In other words, when the computing device 100 detects the above-mentioned abnormal event, the above-mentioned steps S210 to S230 can immediately be executed, and the backup device 200 is notified of the abnormal event, so that the backup device 200 executes the backup virtual machine VM2 according to the first data and the second data when the recovery point objective time is satisfied.

Reference is made to FIG. 2, which is a flowchart of detailed steps S211 of step S210 and step S220 in some embodiments according to the disclosure.

First, suppose that, before a recovery time point, the main virtual machine VM1 has been executed for a period of time, and read/written in the volatile memory 110 and the non-volatile memory 120. In addition, the processor 130 can store virtual machine status data related to the main virtual machine VM1 in the volatile memory 110 and the non-volatile memory 120, where the virtual machine status data includes various kinds of virtual software and a status of various kinds of virtual hardware currently executing in the main virtual machine VM1.

Furthermore, when a time point is 0 (i.e., a backup time point), the processor 130 starts to perform the following data backup. First, in step S211, detecting the cold area and a hot area used by the main virtual machine VM1 from the volatile memory 110 and the non-volatile memory 120.

In some embodiments, the hot area can be another data storage area in the volatile memory 110 and the non-volatile memory 120, and the read-write rate of data in the hot area by the main virtual machine VM1 cannot be less than a preset read-write rate threshold. In some embodiments, the cold area can correspond to a low read-write rate, and the hot area can correspond to a high read-write rate.

In some embodiments, the processor 130 can set half of the recovery point objective time as a first time point T1 at a first backup time point. Then, the processor 130 can calculate an average read-write data amount of the main virtual machine VM1 at one-tenth of the recovery point objective time after the data backup performed previously at subsequent backup time points, and multiply the average read-write data amount by ten to simulate an data amount that can be generated in the entire recovery point objective time. Then, the processor 130 can divide the simulated data amount by a transmission bandwidth with the backup device 200 to generate a required transmission time, and subtract the recovery point objective time and the required transmission time to generate a time difference, so as to select a smaller one among the time difference and half of the recovery point objective time as the first time point T1.

In some embodiments, the processor 130 can continue to record the read-write area of the main virtual machine VM1 in the volatile memory 110 and the non-volatile memory 120 before reaching the first time point T1, and calculate multiple read-write rates corresponding to multiple sub-areas in this read-write area, so as to identify the cold area and the hot area from these sub-areas according to these read-write rates.

Furthermore, in step S220, transmitting first data belonging to the cold area in the volatile memory 110 and the non-volatile memory 120 to the backup device 200.

In some embodiments, the first data can be data which has been transmitted when the data in the cold area has been transmitted to the backup device 200 by one-tenth of the data in the cold area, or can also be the data in the cold area that can be transmitted within three-quarters of the recovery point objective time. In other words, regardless of whether one-tenth of the data amount in the cold area is transmitted first or three-quarters of the recovery point objective time is reached first, the transmission of the data in the cold area will be stopped, and the data which has been transmitted is the first data.

In detail, when the processor 130 determines that one-tenth of the data amount in the cold area (the first transmission threshold) has been transmitted first, and the time taken to start the backup has not reached three-quarters of the target time of the restoration point (Time threshold), the processor 130 may use the time spent for transmission as the second time point T2, and stop transmitting the data in the cold area.

When the processor 130 determines that one-tenth of the data amount in the cold area (the first transmission threshold) has been transmitted first and the time taken to start the backup has not reached three-quarters (Time threshold) of the recovery point objective time, the processor 130 can use a time spent for the transmission as a second time point T2, and stop transmitting the data in the cold area. In other words, the computing device 100 can continuously transmit data in the cold area to the backup device 200 before the second time point T2, where the data transmitted before the second time point T2 is the above-mentioned first data, and the data amount of the first data is equal to the first transmission threshold or the time spent for transmitting the first data is equal to the time threshold is the above-mentioned first transmission condition.

It should be noted that since the first data of the cold zone has been transmitted in advance, subsequent backup will greatly save the transmission bandwidth.

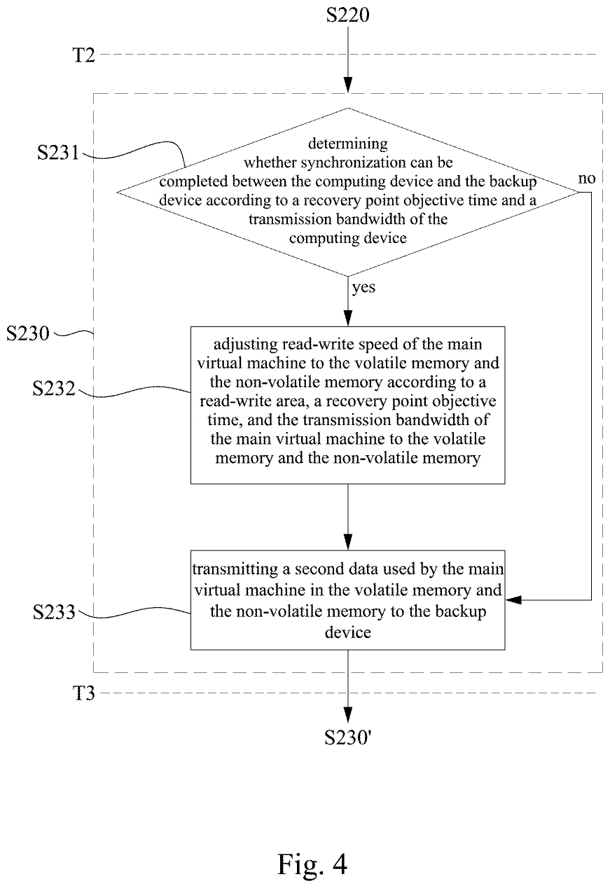

Reference is made to FIG. 4, which is a flowchart of detailed steps S231 to S233 of step S230 in some embodiments according to the disclosure.

After the second time point T2, in step S231, determining whether synchronization can be completed between the computing device 100 and the backup device 200 according to the recovery point objective time and the transmission bandwidth of the computing device 100. When it is determined that the synchronization cannot be completed, enter to step S232. On the contrary, when it is determined that the synchronization can be completed, enter to step S233.

In some embodiments, the processor 130 can detect data amount of the main virtual machine VM1 to the read-write area of the volatile memory 110 and the non-volatile memory 120, and calculate estimated transmission time according to the data amount and the transmission bandwidth of the computing device 100. Then, the processor 130 can determine whether the estimated transmission time is less than the recovery point objective time. When the processor 130 determines that the estimated transmission time is not less than the recovery point objective time, the processor 130 can determine that the synchronization cannot be completed, and enter to step S232. On the contrary, when the processor 130 determines that the estimated transmission time is less than the recovery point objective time, the processor 130 can determine that the synchronization can be completed, and enter to step S233.

Furthermore, in step S232, adjusting read-write speed of the main virtual machine VM1 to the volatile memory 110 and the non-volatile memory 120 according to the read-write area, the recovery point objective time, and the transmission bandwidth of the main virtual machine VM1 to the volatile memory 110 and the non-volatile memory 120.

In some embodiments, the processor 130 can calculate the estimated transmission time according to the data amount of the read-write area of the main virtual machine VM1 to the volatile memory 110 and the non-volatile memory 120 and the transmission bandwidth of the computing device 100. Then, the processor 130 can calculate a ratio between the estimated transmission time and the recovery point objective time, and multiply the ratio with the above-mentioned read-write speed to generate an adjusted read-write speed, so as to let the main virtual machine VM1 read/write the volatile memory 110 and the non-volatile memory 120 according to the adjusted read-write speed.

It should be noted that, since the read-write speed has been limited, it will be guaranteed that these backup steps can be completed within the recovery point objective time.

Furthermore, in step S233, transmitting a second data used by the main virtual machine VM1 in the volatile memory 110 and the non-volatile memory 120 to the backup device 200.

In some embodiments, the processor 130 can establish a backup checkpoint at the second time point T2. In other words, these steps are to restore the data of the backup virtual machine VM2 to this backup checkpoint when an abnormal event occurs in the future.

In some embodiments, the processor 130 can use a part of the remaining data except the first data in the read-write area of the main virtual machine VM1 to the volatile memory 110 and the non-volatile memory 120 as the second data, to transmit the second data to the backup device 200, and use a time point when the second data has been transmitted completely as a third time point T3, where the data amount of the second data can be a data amount that satisfy a preset second transmission threshold, and the data amount of the second data can be equal to the second transmission threshold is the above-mentioned second transmission condition.

In some embodiments, after the third time point T3, the processor 130 can execute step S240, or can execute an additional step S230′ before executing step S240.

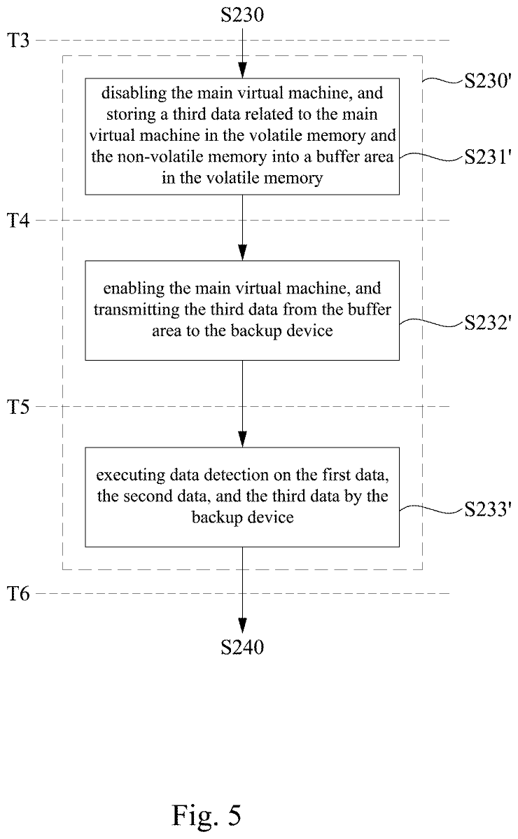

Reference is made to FIG. 5, which is a flowchart of detailed steps S231′ to S233′ of step S230′ after step S230 in some embodiments according to the disclosure.

First, in step S231′, disabling the main virtual machine VM1, and storing a third data related to the main virtual machine VM1 in the volatile memory 110 and the non-volatile memory 120 into a buffer area in the volatile memory 110.

In some embodiments, the buffer area can be a temporary data storage area in the volatile memory 110 and the non-volatile memory 120 as a temporary storage space for data, so as to buffer a data transmission speed between the volatile memory 110, the non-volatile memory 120, and other devices or hardware. In some embodiments, the third information can include remaining data, which is except the first data and the second data, of the main virtual machine VM1 to the read-write area of the volatile memory 110 and the non-volatile memory 120, and include the virtual machine status data of a virtual hardware and a virtual software corresponding to the main virtual machine VM1. In other words, the third data can include two types of data, where a first type of data is the remaining data of the non-first data and the non-second data in the above-mentioned read-write area, and the second type of data is the status data of various kind of virtual software and hardware of the main virtual machine VM1.

In one embodiment, the processor 130 can use a time point when the third data is completely stored in the buffer area in the volatile memory 110 as a fourth time point T4, and execute step S232′ at the fourth time point T4.

Furthermore, in step S232′, enabling the main virtual machine VM1, and transmitting the third data from the buffer area to the backup device 200. It should be noted that since a data amount of the third data is quite small, the transmission bandwidth required at this time is also quite small.

In one embodiment, the processor 130 can use a time point when the third data is completely transmitted to the backup device 200 as a fifth time point T5, and execute step S233′ at the fifth time point T5.

Furthermore, in step S233′, executing data detection on the first data, the second data, and the third data by the backup device 200.

In some embodiments, the backup device 200 can detect the correctness and completeness of the received first data, second data, and third data, where a detection method can include usage of checksum detection and data structure completeness detection (e.g., SHA256, XXH3 and other algorithms). Then, when the backup device 200 has confirmed the correctness and completeness of the first data, the second data, and the third data, the backup device 200 can store the first data, the second data, and the third data to restore to a state of the above-mentioned backup checkpoint at any time.

In one embodiment, the processor 130 can use a time point when the data detection on the first data, the second data, and the third data is completed as a sixth time point T6, and execute step S240 after the sixth time point T6 and an abnormal event has occurred.

It should be noted that through the above-mentioned steps, the backup device 200 can complete the backup before the sixth time point T6, and the sixth time point T6 can satisfy requirement of the recovery point objective time. In addition, the recovery point objective time and other related conditions (virtual machine specifications, instant write load of the volatile memory 110 and the non-volatile memory 120) can affect the sixth time point T6, and the shorter recovery point objective time makes the shorter overall time spent before the sixth time point T6. That is, a frequency of synchronization between virtual machines per unit time increases, which in turn increases the bandwidth of usage between virtual machines.

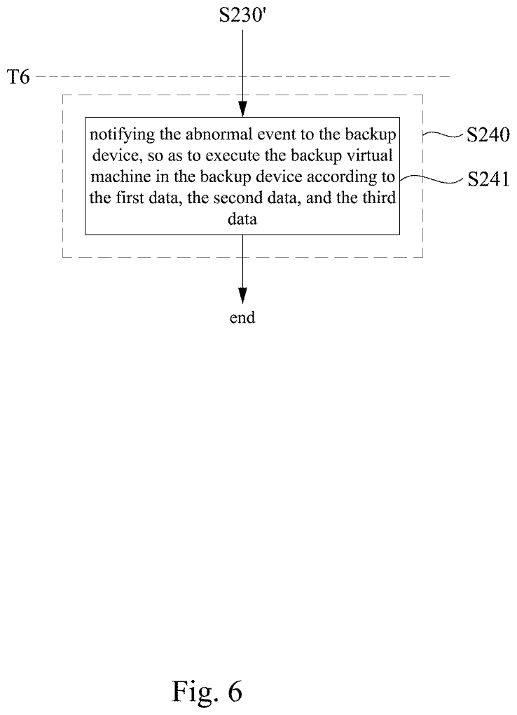

Reference is made to FIG. 6, which is a flowchart of detailed step S241 of step S240 in some embodiments according to the disclosure. Furthermore, in step S241, notifying the abnormal event to the backup device 200, so as to execute the backup virtual machine VM2 in the backup device 200 according to the first data, the second data, and the third data.

In detail, when the processor 130 determines that the abnormal event has occurred, the processor 130 notifies the backup device 200 of the abnormal event. At this time, the backup device 200 can directly execute the backup virtual machine VM2 according to the pre-stored first data, second data, and third data, so as to restore the data and status of the main virtual machine VM1 in the backup virtual machine VM2.

It should be noted that the above-mentioned backup of the first data, the second data, and the third data to the backup device 200 can be executed by a virtual machine monitor (not shown) executed by the processor 130, and processing of the first data, the second data, and the third data on the backup device 200 can also be executed by another virtual machine monitor (not shown) in the backup device 200. Therefore, no additional software interface is needed to process these data backups.

On the other hand, when the transmission between the above-mentioned computing device 100 and the backup device 200 is performed, the processor 130 can further control the data transmission according to a transmission situation in real time. The following is an explanation with a practical example.

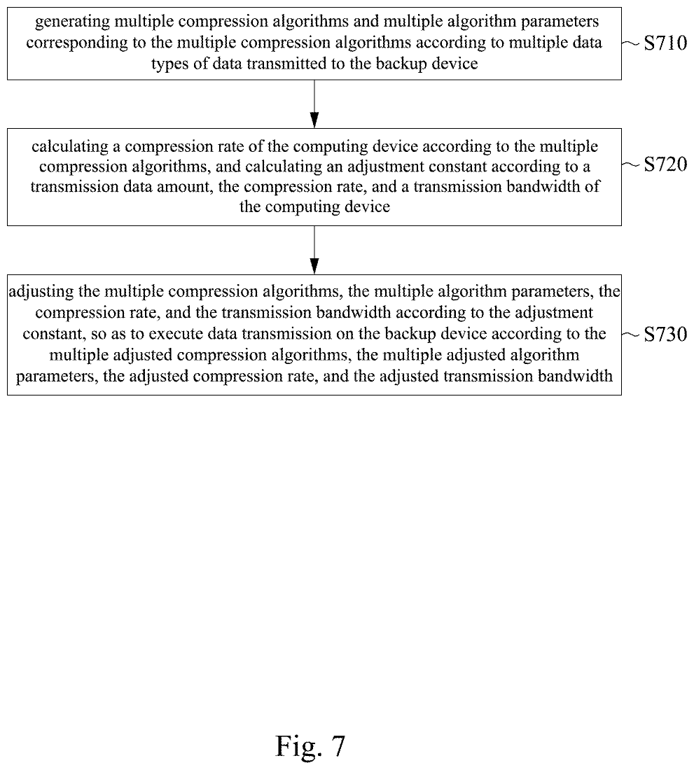

Reference is made to FIG. 7, which is a flowchart of controlling data transmission in the data backup method in some embodiments according to the disclosure.

First, in step S710, generating multiple compression algorithms and multiple algorithm parameters corresponding to the multiple compression algorithms according to multiple data types of data transmitted to the backup device 200.

In some embodiments, the processor 130 can generate compression algorithms and algorithm parameters corresponding to the types of data to be transmitted according to the types of data to be transmitted, its own computing power, and the transmission bandwidth of the computing device 100.

For example, for data of a virtual processor of the main virtual machine VM1, a Lz4 compression algorithm, a DEFLATE compression algorithm, or a ZSTD compression algorithm can be used. For data of a virtual peripheral machine of the main virtual machine VM1, when the transmission bandwidth is high, a differential compression algorithm can be used. On the contrary, when the transmission bandwidth is low, the differential compression algorithm can be used with a run-length encoding (RLE) compression algorithm and various kinds of general compression algorithms (a Lz4 compression algorithm, a ZSTD compression algorithm or a DEFLATE compression algorithm). For data of the main virtual machine VM1 in the volatile memory 110, when the transmission bandwidth is high, the RLE compression algorithm including a cache mechanism can be used. On the contrary, when the transmission bandwidth is low, various kinds of general compression algorithms (the Lz4 compression algorithm, the ZSTD compression algorithm or the DEFLATE compression algorithm) can be used. For the data of the disc image file of the main virtual machine VM1, various kinds of general compression algorithms (the Lz4 compression algorithm, the ZSTD compression algorithm or the DEFLATE compression algorithm) can also be used.

In some embodiments, in an initial state, the processor 130 can detect a transmission bandwidth of the computing device 100 during the first data transmission to facilitate subsequent adjustments to the transmission bandwidth. In some embodiments, in a non-initial state, the processor 130 can detect a transmission bandwidth of the computing device 100 during the previous data transmission period to facilitate subsequent adjustments to the transmission bandwidth.

Furthermore, in step S720, calculating a compression rate of the computing device 100 according to the multiple compression algorithms, and calculating an adjustment constant according to a transmission data amount, the compression rate, and a transmission bandwidth of the computing device 100.

In some embodiments, in the initial state, the processor 130 can calculate the compression rate of the computing device 100 according to the multiple compression algorithms during the first data transmission to facilitate subsequent adjustments of the compression rate. In the non-initial state, the processor 130 can calculate the compression rate of the computing device 100 according to the multiple compression algorithms in the previous data transmission period to facilitate subsequent adjustments of the compression rate.

In some embodiments, the processor 130 can periodically detect a available transmission bandwidth, transmission elapsed time, and compression ratio of the computing device 100 through the network detection circuit.

In some embodiments, the processor 130 can calculate theoretical estimated transmission time according to a data amount transmitted by the computing device 100, the compression rate, and the transmission bandwidth in each data transmission time period (e.g., the above-mentioned second time point T2 to the above-mentioned third time point T3), and detect actual transmission time in each data transmission time period. Then, the processor 130 can calculate a ratio between the estimated transmission time and the actual transmission time as the adjustment constant.

Furthermore, in step S730, adjusting the multiple compression algorithms, the multiple algorithm parameters, the compression rate, and the transmission bandwidth according to the adjustment constant, so as to execute data transmission on the backup device 200 according to the multiple adjusted compression algorithms, the multiple adjusted algorithm parameters, the adjusted compression rate, and the adjusted transmission bandwidth.

In some embodiments, the processor 130 can multiply the adjustment constant by the compression rate and the transmission bandwidth to generate the adjusted compression rate and the adjusted transmission bandwidth, and adjust the multiple compression algorithms and the multiple algorithm parameters to generate the adjusted compression algorithm and the adjusted algorithm parameters according to the adjusted compression rate and the adjusted transmission bandwidth. For example, the above-mentioned various kinds of compression algorithms are reselected or combined according to the adjusted compression rate and the adjusted transmission bandwidth, or these algorithm parameters of these current compression algorithms are adjusted according to the adjusted compression rate and the adjusted transmission bandwidth. In other words, the adjustment constant can correspond to the multiple compression algorithms and can be used to adjust the multiple algorithm parameters of the multiple compression algorithms. For example, the ratio between the estimated transmission time and the actual transmission time can be used to adjust the multiple algorithm parameters.

It should be noted that the above-mentioned adjustments are based on the compression algorithms, algorithm parameters, compression rate, and transmission bandwidth of the initial state or the previous transmission time period for subsequent adjustments.

In summary, the computing device and data backup method of the embodiments of the disclosure can use data partitioning and time-sharing transmission to back up the data of the main virtual machine of the computing device to the remoted backup device, so as to let the remoted backup device execute the backup virtual machine according to the backup data in the environment with limited bandwidth when an abnormal event occurred. In addition, the compression algorithms, algorithm parameters, compression rate, and transmission bandwidth of the computing device can be adjusted in real time periodically according to the transmission status, so as to completely backup the data to the backup device in the environment with varying bandwidth.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A computing device, comprising:
a volatile memory;
a non-volatile memory; and
a processor connected to the volatile memory and the non-volatile memory, wherein the processor is configured to execute a main virtual machine for:
during a detection period, detecting a cold area used by the main virtual machine from the volatile memory and the non-volatile memory;
transmitting first data belonging to the cold area in the volatile memory and the non-volatile memory to a backup device;
when determining that a first transmission condition is satisfied, transmitting a second data used by the main virtual machine in the volatile memory and the non-volatile memory to the backup device; and
when determining that an abnormal event has occurred, notifying the abnormal event to the backup device, so as to execute a backup virtual machine in the backup device according to the first data and the second data.

2. The computing device of claim 1, wherein the processor is configured for:
when determining that a second transmission condition is satisfied, disabling the main virtual machine, and storing a third data related to the main virtual machine in the volatile memory and the non-volatile memory into a buffer area in the volatile memory;
enabling the main virtual machine, and transmitting the third data from the buffer area to the backup device; and
when determining that the abnormal event has occurred, notifying the abnormal event to the backup device, so as to execute the backup virtual machine in the backup device according to the first data, the second data, and the third data.

3. The computing device of claim 2, wherein the processor is configured for:
during the detection period, detecting the cold area and a hot area used by the main virtual machine from the volatile memory and the non-volatile memory, wherein the first data in the cold area corresponds to a low read-write rate, wherein the third data is stored in the hot area and corresponds to a high read-write rate.

4. The computing device of claim 2, wherein the detection period is decided by a recovery point objective time, wherein the first transmission condition is that a data amount of the first data is equal to a first transmission threshold or time taken to transmit the first data is equal to a time threshold, wherein the second transmission condition is that a data amount of the second data is equal to a second transmission threshold.

5. The computing device of claim 2, wherein the processor is configured for:
when determining that a first transmission condition is satisfied, determining whether synchronization can be completed between the computing device and the backup device according to a recovery point objective time and a transmission bandwidth of the computing device; and
when determining that a first transmission condition is not satisfied, adjusting read-write rate of the main virtual machine to the volatile memory and the non-volatile memory according to a read-write area, the recovery point objective time, and the transmission bandwidth of the main virtual machine for the volatile memory and the non-volatile memory.

6. The computing device of claim 1, wherein the processor is configured for:
generating a plurality of compression algorithms and a plurality of algorithm parameters corresponding to the plurality of compression algorithms according to a plurality of data types of data transmitted to the backup device, and executing data transmission on the backup device according to the plurality of compression algorithms and the plurality of algorithm parameters.

7. The computing device of claim 6, wherein the processor is configured for:
calculating a compression rate of the computing device according to the plurality of compression algorithms, and calculating an adjustment constant according to a transmission data amount, the compression rate, and a transmission bandwidth of the computing device; and
adjusting the plurality of compression algorithms, the plurality of algorithm parameters, the compression rate, and the transmission bandwidth according to the adjustment constant, so as to execute data transmission on the backup device according to the plurality of adjusted compression algorithms, the plurality of adjusted algorithm parameters, the adjusted compression rate, and the adjusted transmission bandwidth.

8. A data backup method, comprising:
during a detection period, by a computing device, detecting a cold area used by a main virtual machine from a volatile memory and a non-volatile memory;
by the computing device, transmitting first data belonging to the cold area in the volatile memory and the non-volatile memory to a backup device;
when determining that a first transmission condition is satisfied, by the computing device, transmitting a second data used by the main virtual machine in the volatile memory and the non-volatile memory to the backup device; and
when determining that an abnormal event has occurred, by the computing device, notifying the abnormal event to the backup device, so as to execute a backup virtual machine in the backup device according to the first data and the second data.

9. The data backup method of claim 8, further comprising:
when determining that a second transmission condition is satisfied, disabling the main virtual machine, and storing a third data related to the main virtual machine in the volatile memory and the non-volatile memory into a buffer area in the volatile memory;
enabling the main virtual machine, and transmitting the third data from the buffer area to the backup device; and
when determining that the abnormal event has occurred, notifying the abnormal event to the backup device, so as to execute the backup virtual machine in the backup device according to the first data, the second data, and the third data.

10. The data backup method of claim 9, further comprising:
during the detection period, detecting the cold area and a hot area used by the main virtual machine from the volatile memory and the non-volatile memory, wherein the first data in the cold area corresponds to a low read-write rate, wherein the third data is stored in the hot area and corresponds to a high read-write rate.

11. The data backup method of claim 9, wherein the detection period is decided by a recovery point objective time, wherein the first transmission condition is that a data amount of the first data is equal to a first transmission threshold or time taken to transmit the first data is equal to a time threshold, wherein the second transmission condition is that a data amount of the second data is equal to a second transmission threshold.

12. The data backup method of claim 9, further comprising:
when determining that a first transmission condition is satisfied, determining whether synchronization can be completed between the computing device and the backup device according to a recovery point objective time and a transmission bandwidth of the computing device; and
when determining that a first transmission condition is not satisfied, adjusting read-write rate of the main virtual machine to the volatile memory and the non-volatile memory according to a read-write area, the recovery point objective time, and the transmission bandwidth of the main virtual machine for the volatile memory and the non-volatile memory.

13. The data backup method of claim 8, further comprising:
generating a plurality of compression algorithms and a plurality of algorithm parameters corresponding to the plurality of compression algorithms according to a plurality of data types of data transmitted to the backup device, and executing data transmission on the backup device according to the plurality of compression algorithms and the plurality of algorithm parameters.

14. The data backup method of claim 13, further comprising:
calculating a compression rate of the computing device according to the plurality of compression algorithms, and calculating an adjustment constant according to a transmission data amount, the compression rate, and a transmission bandwidth of the computing device; and
adjusting the plurality of compression algorithms, the plurality of algorithm parameters, the compression rate, and the transmission bandwidth according to the adjustment constant, so as to execute data transmission on the backup device according to the plurality of adjusted compression algorithms, the plurality of adjusted algorithm parameters, the adjusted compression rate, and the adjusted transmission bandwidth.
